(19) United States
(12) Patent Application Publication
(10) Pub. No.: US 2025/0379468 A1
(43) Pub. Date: Dec. 11, 2025

(54) METHOD FOR POWER SYSTEM HAVING QUICK-SWITCH APPARATUS, AND APPARATUS

(71) Applicant: Siemens Aktiengesellschaft, München (DE)

(72) Inventors: Yan Ma, Nanjing (CN); Lei Ming Qin, Nanjing (CN); Klaus Böhme, Berlin (DE); Hai Tao Lian, Nanjing (CN); Fei Wang, Nanjing (CN); Chuan Li Hu, Nanjing (CN)

(21) Appl. No.: 19/107,727

(22) PCT Filed: Aug. 29, 2023
(86) PCT No.: PCT/EP2023/073714

§ 371 Date: Feb. 28, 2025

(30) Foreign Application Priority Data
Aug. 31, 2022 (CN) 202211061353.3

(51) Int. Cl. H02J 9/06

(52) U.S. Cl. CPC H02J 9/06

(57) ABSTRACT

A power system contains a quick-switch apparatus and two power supplies. Each of the power supplies is connected to a bus via an incoming line, one power supply that is currently supplying power serves as a main power supply, and the other power supply serves as a backup power supply. The quick-switch apparatus is used to trigger switching between the two power supplies, and the bus has three phases. A method for operating the power system includes the steps of: monitoring a phase voltage of each phase of the bus; acquiring a rate of decrease of the phase voltage of each phase after the main power supply has been disconnected; and triggering an engagement operation of the backup power supply if the rate of decrease of the phase voltage of each phase is less than or equal to a first preset threshold.

### TECHNICAL FIELD

The present invention relates to the field of power systems, in particular a method for a power system having a quick-switch apparatus, and an apparatus.

### BACKGROUND ART

The power system of many factories has two power supplies: one power supply currently supplying power serves as a main power supply, while the other power supply serves as a backup power supply. Each of the two power supplies is connected to a bus via an incoming line, and each load is connected to the bus via an outgoing line. In general, the load is an asynchronous electric machine. If a fault occurs in the main power supply, the source of power must be switched from the main power supply to the backup power supply as quickly as possible, in order to ensure that power can be used without interruption. In the prior art, quick-switch apparatuses are generally used to switch power supplies.

In the prior art, whether it is necessary to switch power supplies is sometimes judged by monitoring whether a voltage on the bus drops by a certain degree. In some cases, however, the fault is not in the main power supply; in such cases, uninterrupted power usage cannot be guaranteed even if the power supplies are switched. For example, if a fault occurs in an upper-level power supply, the supply of power is interrupted, at which time the voltage on the bus exhibits a decreasing trend. In this case, performing a power supply switching operation will not maintain continuity of power supply.

### SUMMARY OF THE INVENTION

In view of the above, the present invention proposes a method for a power system having a quick-switch apparatus, the power system comprising a quick-switch apparatus and two power supplies, each of the power supplies being connected to a bus via an incoming line, one power supply that is currently supplying power serving as a main power supply, and the other power supply serving as a backup power supply, the quick-switch apparatus being used to trigger switching between the two power supplies, and the bus having three phases, the method comprising: monitoring a phase voltage of each phase of the bus; and the method further comprises:

acquiring the rate of decrease of the phase voltage of each phase after the main power supply has been disconnected;

triggering an engagement operation of the backup power supply if the rate of decrease of the phase voltage of each phase is less than or equal to a first preset threshold.

According to the method as described above, optionally, the step of acquiring the rate of decrease of the phase voltage of each phase comprises:
determining the rate of decrease of the phase voltage of each phase according to the following formula: dU/dt=U(n)−U(n−2T),
where dU/dt represents the rate of decrease of the phase voltage, U(n) represents the value of the nth sampling point of the phase voltage, U(n−2T) represents the value of the (n−2T)th sampling point of the phase voltage, and T represents the period of the phase voltage; or
dU/dt represents the rate of decrease of the phase voltage, U(n) represents the nth amplitude of the phase voltage, U(n−2T) represents the (n−2T)th amplitude of the phase voltage, and T represents the period of the phase voltage.

According to the method as described above, optionally, if the rates of decrease are all greater than the first preset threshold, it is determined that there is a fault connected to the bus, and the engagement operation of the backup power supply is prohibited.

According to the method as described above, optionally, after the engagement operation of the backup power supply is prohibited, the method further comprises:
if it is judged that the phase voltage on each phase exhibits a rising trend, unlocking the function of prohibiting the engagement operation of the backup power supply.

According to the method as described above, optionally, after monitoring the phase voltage of each phase of the bus, the method further comprises:
judging whether a negative sequence voltage occurs on the bus;
if the judgment result is positive, acquiring the ratio of negative sequence voltage to positive sequence voltage of the bus;
monitoring whether the process of variation of the ratio of negative sequence voltage to positive sequence voltage is greater than or equal to a second preset threshold and the negative sequence voltage is less than or equal to a third preset threshold, and if the monitoring result is positive, determining that a phase-to-phase fault of the bus has disappeared;
or
judging whether a zero sequence voltage occurs on the bus;
if the judgment result is positive, acquiring the ratio of zero sequence voltage to positive sequence voltage of the bus;
monitoring whether the process of variation of the ratio of zero sequence voltage to positive sequence voltage is greater than or equal to a fourth preset threshold and the zero sequence voltage is less than or equal to a fifth preset threshold, and if the monitoring result is positive, determining that a ground fault of the bus has disappeared.

The present Invention further provides a quick-switch apparatus, located in a power system that also comprises two power supplies, each of the power supplies being connected to a bus via an incoming line, one power supply that is currently supplying power serving as a main power supply, and the other power supply serving as a backup power supply, the quick-switch apparatus being used to trigger switching between the two power supplies, the bus having three phases, and the quick-switch apparatus comprising a first monitoring unit for monitoring a phase voltage of each phase of the bus;
the quick-switch apparatus further comprises:
a first acquisition unit, for acquiring the rate of decrease of the phase voltage of each phase after the main power supply has been disconnected;
a judgment unit, for judging whether the rate of decrease of the phase voltage of each phase is less than or equal to a first preset threshold, and if the judgment result is positive, triggering a trigger unit;
the trigger unit, for triggering an engagement operation of the backup power supply.

According to the quick-switch apparatus as described above, optionally, the first acquisition unit is specifically used to:
determine the rate of decrease of the phase voltage of each phase according to the following formula: Du/dt=U(n)−U(n−2T),
where dU/dt represents the rate of decrease of the phase voltage, U(n) represents the value of the nth sampling point of the phase voltage, U(n−2T) represents the value of the (n−2T)th sampling point of the phase voltage, and T represents the period of the phase voltage; or
dU/dt represents the rate of decrease of the phase voltage, U(n) represents the nth amplitude of the phase voltage, U(n−2T) represents the (n−2T)th amplitude of the phase voltage, and T represents the period of the phase voltage.

According to the quick-switch apparatus as described above, optionally, if the judgment result of the judgment unit is negative, it is determined that there is a fault connected to the bus, and the trigger unit is disabled.

According to the quick-switch apparatus as described above, optionally, the judgment unit is further used to: unlock the trigger unit if it is judged that the phase voltage on each phase exhibits a rising trend.

According to the quick-switch apparatus as described above, optionally, the judgment unit is further used to: judge whether a negative sequence voltage occurs on the bus, and if the judgment result is positive, trigger a second acquisition unit;
the second acquisition unit is used to acquire the ratio of negative sequence voltage to positive sequence voltage of the bus;
the apparatus further comprises a second monitoring unit, for monitoring whether the process of variation of the ratio of negative sequence voltage to positive sequence voltage is greater than or equal to a second preset threshold and the negative sequence voltage is less than or equal to a third preset threshold, and if the monitoring result is positive, determining that a phase-to-phase fault of the bus has disappeared; or
the judgment unit is further used to: judge whether a negative/zero sequence voltage occurs on the bus, and if the judgment result is positive, trigger a second acquisition unit;
the second acquisition unit is used to acquire the ratio of zero sequence voltage to positive sequence voltage of the bus;
the second monitoring unit is used for monitoring whether the process of variation of the ratio of zero sequence voltage to positive sequence voltage is greater than or equal to a fourth preset threshold and the zero sequence voltage is less than or equal to a fifth preset threshold, and if the monitoring result is positive, determining that a ground fault of the bus has disappeared.

The present invention provides another quick-switch apparatus, which optionally comprises:
at least one memory, for storing an instruction;
at least one processor, for executing the method for a power system having a quick-switch apparatus as described in any of the embodiments above according to the instruction stored in the memory.

The present invention further provides a readable storage medium; the readable storage medium has a machine-readable instruction stored therein, and when the machine-readable instruction is executed by a machine, the machine executes the method for a power system having a quick-switch apparatus as described in any of the embodiments above.

According to the invention, after the main power supply has been disconnected, the rate of decrease of the phase voltage of each phase is monitored to determine whether to trigger the engagement operation of the backup power supply, and it is thus possible to avoid the problems of erroneous engagement or inability to engage promptly.

### BRIEF DESCRIPTION OF THE DRAWINGS

Preferred embodiments of the present invention are described in detail below with reference to the drawings, to give those skilled in the art a clearer understanding of the abovementioned and other features and advantages of the present invention. In the drawings:

FIG. 1 is a schematic flow chart of the method for a power system having a quick-switch apparatus according to an embodiment of the present invention.

FIG. 2 is a schematic flow chart of the method for a power system having a quick-switch apparatus according to another embodiment of the present invention.

FIG. 3 is a schematic flow chart of the method for a power system having a quick-switch apparatus according to another embodiment of the present invention.

FIG. 4 is a schematic flow chart of the method for a power system having a quick-switch apparatus according to another embodiment of the present invention.

FIG. 5 is a schematic structural diagram of the quick-switch apparatus according to an embodiment of the present invention.

FIG. 6 is a schematic structural diagram of the quick-switch apparatus according to another embodiment of the present invention.

### DETAILED DESCRIPTION OF THE INVENTION

To clarify the objective, technical solution and advantages of the present invention, the present invention is explained in further detail below through embodiments.

In the case of a power system having a quick-switch apparatus, if a fault occurs in the power system, the quick switch apparatus will be prohibited from triggering power supply switching, and it is necessary to wait until the fault has been eliminated before switching the power supplies. This is because, if a fault is connected to the bus, a sustained supply of power cannot be achieved even if the power supplies are switched. Here, the expression “a fault is connected to the bus” may mean that a fault is present in the bus itself, or that a fault has occurred in a circuit directly or indirectly connected to the bus and consequently a fault is present in the bus, e.g. a fault has occurred in an upper-level power supply.

Faults that occur in power systems mainly include the following types: the first type is single-phase ground faults, in which a zero sequence voltage will occur in the power system; the second type is phase-to-phase short circuit faults, in which a negative sequence voltage will occur in the power system; the third type is three-phase short circuit faults, in which the phase voltage of each phase of the power system exhibits a decreasing trend, and if the phase voltages on the three phases all decrease to a threshold, the quick-switch apparatus will be prohibited from triggering a power supply switching operation. However, if a fault occurs in the main power supply or the incoming line to which the main power supply is connected, it is necessary to disconnect the main power supply and switch to the backup power supply; in this way, the fault can be eliminated and continuity of power usage can be ensured. When the main power supply is disconnected, the phase voltage of each phase of the bus is also decreasing because the bus has no supply of power; if it decreases to the threshold, triggering of the power supply switching operation will be prohibited. Here, the phase voltage means the voltage between the neutral line and any phase line among the three live lines.

On this basis, the inventors have provided a method for a power system having a quick-switch apparatus, to avoid erroneously prohibiting power supply switching operations.

### Embodiment 1

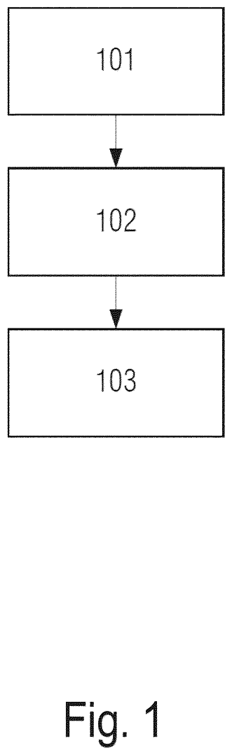

This embodiment provides a method for a power system having a quick-switch apparatus, the power system comprising a quick-switch apparatus and two power supplies, each power supply being connected to a bus via an incoming line; one power supply currently supplying power serves as a main power supply, the other power supply serves as a backup power supply, the quick-switch apparatus is used to trigger switching between the two power supplies, and the bus has three phases-phase A, phase B and phase C, as shown in FIG. 1. In the method for a power system having a quick-switch apparatus, the executing main body is the quick-switch apparatus.

FIG. 1 shows a schematic flow chart of the method for a power system having a quick-switch apparatus according to this embodiment. The method comprises:
Step 101, monitoring a phase voltage of each phase of the bus.

The phase voltages may be acquired by real-time measurement; for example, real-time monitoring is performed via a voltage transformer connected to the bus. The monitoring of the phase voltages of the bus may be continuous. The way in which the phase voltage of each phase of the bus is monitored is prior art, so is not described again here.

Step 102, after the main power supply has been disconnected, acquiring the rate of decrease of the phase voltage of each phase.

In the case of a power system that is in the process of quick switching, when the main power supply thereof is disconnected but the backup power supply has not yet been engaged, the phase voltage of each phase on the bus is decreasing. The rate of decrease represents the extent of the decrease in phase voltage within a period of time, and may be determined using phase voltage sampling point values or phase voltage amplitude.

Step 103, if the rate of decrease of the phase voltage of each phase is less than or equal to a first preset threshold, an engagement operation of the backup power supply is triggered.

The phase voltages on the bus decrease more quickly when a fault occurs in the power system, and decrease more slowly when the main power supply is disconnected but the backup power supply has not yet been engaged. For example, in the event of a power system fault, the phase voltages of the bus might drop to half the rated voltage of the power system within 10 ms, whereas if the main power supply is disconnected, the phase voltages of the bus might drop by about 5% within 10 ms. Therefore, the rate of decrease of the phase voltage can be used to judge whether there is currently a fault connected to the bus. If a fault occurs in the incoming line or the main power supply, the main power supply is disconnected, which is equivalent to clearing the fault on the power system. At this time, there is no fault connected to the bus, so the backup power supply can be engaged. In this way it is possible to avoid a situation where normal supply of power cannot be achieved even by engaging the backup power supply.

The first preset threshold in this embodiment may be determined on the basis of actual needs, e.g. 5%; no further details are given here.

Triggering the engagement operation of the backup power supply means that the backup power supply is engaged when a certain condition is met; the specific way of determining whether the engagement condition is met is prior art, so is not described again here.

Optionally, if the rates of decrease are all greater than the first preset threshold, it is determined that there is a fault connected to the bus, and the engagement operation of the backup power supply is prohibited. That is to say, there is still a fault connected to the bus when the main power supply is disconnected, in which case it is necessary to lock the engagement operation of the backup power supply. Incorrect engagement might result in the fault having more serious consequences.

According to this embodiment, after the main power supply has been disconnected, the rate of decrease of the phase voltage of each phase is monitored to determine whether to trigger the engagement operation of the backup power supply, and it is thus possible to avoid the problems of erroneous engagement or inability to engage promptly.

### Embodiment 2

This embodiment provides a supplementary explanation of the method of embodiment 1 for identifying a fault in a power system.

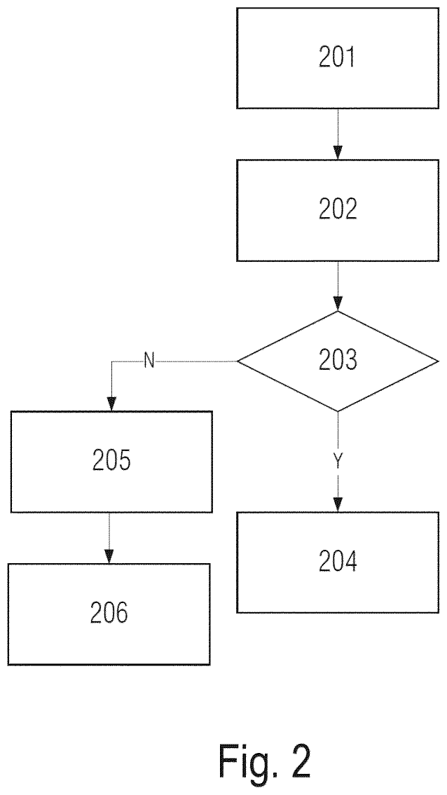

FIG. 2 shows a schematic flow chart of the method for identifying a fault in a power system according to this embodiment. The method comprises:
Step 201, monitoring the phase voltage of each phase of the bus.

The phase voltages may be acquired by real-time measurement; for example, real-time monitoring is performed via a voltage transformer connected to the bus. The monitoring of the phase voltages of the bus may be continuous.

Step 202, after the main power supply has been disconnected, acquiring the rate of decrease of the phase voltage of each phase.

Specifically, the following formula may be used to acquire the rate of decrease of the phase voltage of each phase:

dU/dt=U(n)−U(n−2T),
where dU/dt represents the rate of decrease of the phase voltage, U(n) represents the value of the nth sampling point of the phase voltage, U(n−2T) represents the value of the (n−2T)th sampling point of the phase voltage, and T represents the period of the phase voltage; or
dU/dt represents the rate of decrease of the phase voltage, U(n) represents the nth amplitude of the phase voltage, U(n−2T) represents the (n−2T)th amplitude of the phase voltage, and T represents the period of the phase voltage.

The phase voltage mentioned above represents the phase voltage of each phase; monitoring of the phase voltage is periodic sampling of the value of the phase voltage. Here, the value of the sampling point of the phase voltage means one original sampling value of the phase voltage, and the amplitude of the phase voltage is obtained on the basis of multiple sampling points of the phase voltage within one period; for example, the root mean square of half a period is found, to compute the amplitude of the phase voltage. Specifically, other methods may also be used, but no further details are given here. As for which phase voltage sampling point is taken to be the first sampling point or the first amplitude, the choice can be made according to actual needs; no further details are given here.

Sampling points of the phase voltage that are separated by two periods or amplitudes of the phase voltage that are separated by two periods are compared to determine the rate of decrease of the phase voltage; the real-time quality is good, and computation is simple, quick and convenient.

Step 203, judging whether the rate of decrease of the phase voltage of each phase is less than or equal to a first preset threshold; if the judgment result is positive, then step 204 is performed, otherwise step 205 is performed.

The first preset threshold can be set according to actual needs, e.g. 5%.

Step 204, triggering an engagement operation of the backup power supply.

That is, the backup power supply may be engaged when an engagement condition is met, to ensure the continuity of power supply.

Step 205, prohibiting the engagement operation of the backup power supply, and performing step 206.

For example, a locking instruction may be sent to the quick-switch apparatus, to prohibit the quick-switch apparatus from engaging the backup power supply. Step 206, if it is judged that the phase voltage on each phase exhibits a rising trend, then the function of prohibiting the engagement operation of the backup power supply is unlocked.

The phase voltage of each phase on the bus is continuously monitored; if it is judged that the phase voltage of each phase exhibits a rising trend, then this indicates that there is no longer any fault connected to the bus at this time, and the engagement operation may be performed on the backup power supply if the engagement condition is met.

In the case of a power system in which there is no fault connected to the bus and the main power supply has already been disconnected: due to the action of the asynchronous electric motor as the load, the motor will temporarily act as a generator and supply power to the bus, and for this reason, a situation will occur in which the phase voltage of each phase exhibits a rising trend.

In this embodiment, after the main power supply has been disconnected, the rate of decrease of the phase voltage of each phase is monitored to determine whether to trigger the engagement operation of the backup power supply, and it is thus possible to avoid the problems of erroneous engagement or inability to engage promptly; moreover, it is also possible to determine whether there is a fault connected to the bus by means of the trend of variation of the phase voltage. This is very simple and convenient.

### Embodiment 3

This embodiment provides a supplementary explanation of the method of the previous embodiment for a power system having a quick-switch apparatus. In the case of an phase-to-phase short circuit fault, a negative sequence voltage will occur in the power system; at this time, there is also a positive sequence voltage on the bus. In the prior art, if it is determined that the negative sequence voltage is less than or equal to a threshold, then it is concluded that the phase-to-phase fault of the bus has already disappeared. However, in fact, it might be that continuous attenuation of the voltage on the bus has caused the negative sequence voltage to decrease too, and even fall to the threshold or below, but the fault has actually not disappeared. If the backup power supply is engaged erroneously at this time, there might be serious consequences.

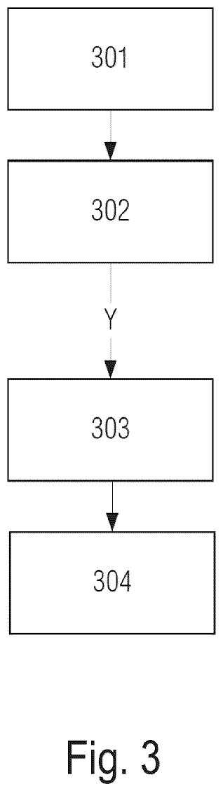

On this basis, as shown in FIG. 3, the inventors have thought of the following method for a power system having a quick-switch apparatus.

Step 301, monitoring the phase voltage of each phase of the bus.

The phase voltages may be acquired by real-time measurement; for example, real-time monitoring is performed via a voltage transformer connected to the bus. The monitoring of the phase voltages of the bus may be continuous.

Step 302, judging whether a negative sequence voltage of the bus is greater than a positive sequence voltage; if the judgment result is positive, then step 303 is performed.

A negative sequence voltage on the bus indicates a phase-to-phase fault on the bus. The negative sequence voltage is computed on the basis of the voltages of the three phases of the bus; the specific method of computation is prior art, so is not described again here.

Step 303, acquiring the ratio of negative sequence voltage to positive sequence voltage of the bus.

For example, the ratio is negative sequence voltage/positive sequence voltage.

Step 304, monitoring whether the process of variation of the ratio of negative sequence voltage to positive sequence voltage is greater than or equal to a second preset threshold and the negative sequence voltage is less than or equal to a third preset threshold; if the monitoring result is positive, then it is determined that the phase-to-phase fault of the bus has disappeared.

In the case of a phase-to-phase fault on a bus, the ratio of negative sequence voltage to positive sequence voltage will not change much, regardless of how the residual voltage on the bus attenuates. Therefore, the ratio of negative sequence voltage to positive sequence voltage can be monitored, and if it is found that the change therein is large and the negative sequence voltage has already reached the third preset threshold or below, it can be determined that the bus fault has disappeared. Here, the second preset threshold and the third preset threshold may be set according to actual needs.

Once the phase fault has disappeared, a subsequent operation may be performed, for example, unlocking the power supply switching function of the quick-switch apparatus, or triggering the engagement operation of the backup power supply; further details are not given here.

In this embodiment, by monitoring the ratio of negative sequence voltage to positive sequence voltage of the bus where the phase-to-phase fault has occurred, it is possible to determine precisely whether the phase-to-phase fault of the bus has disappeared.

### Embodiment 4

This embodiment provides a supplementary explanation of the method of the previous embodiment for a power system having a quick-switch apparatus.

In the case of a single-phase ground fault, a zero sequence voltage will occur in the power system; at this time, there is also a positive sequence voltage on the bus where the fault has arisen. In the prior art, if it is determined that the zero sequence voltage is less than or equal to a threshold, then it is concluded that the fault has already disappeared. However, in fact, it might be that continuous attenuation of the voltage on the bus has caused the zero sequence voltage to decrease too, and even fall to the threshold or below, but the fault has actually not disappeared. If the backup power supply is engaged erroneously at this time, there might be serious consequences.

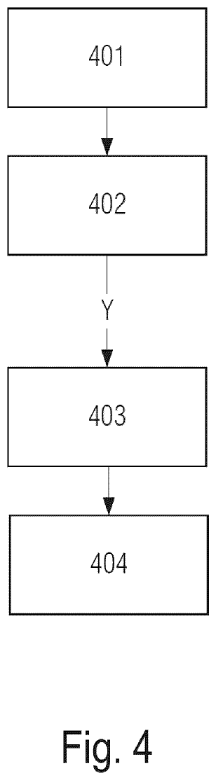

On this basis, as shown in FIG. 4, the inventors have thought of the following method for a power system having a quick-switch apparatus.

Step 401, monitoring a phase voltage of each phase of the bus.

The phase voltages may be acquired by real-time measurement; for example, real-time monitoring is performed via a voltage transformer connected to the bus. The monitoring of the phase voltages of the bus may be continuous.

Step 402, judging whether a zero sequence voltage of the bus is greater than a positive sequence voltage; if the judgment result is positive, then step 403 is performed.

A zero sequence voltage on the bus indicates a ground fault on the bus. The zero sequence voltage is computed on the basis of the voltages of the three phases of the bus; the specific method of computation is prior art, so is not described again here.

Step 403, acquiring the ratio of zero sequence voltage to positive sequence voltage of the bus.

For example, the ratio is zero sequence voltage/positive sequence voltage.

Step 404, monitoring whether the process of variation of the ratio of zero sequence voltage to positive sequence voltage is greater than or equal to a fourth preset threshold and the zero sequence voltage is less than or equal to a fifth preset threshold; if the monitoring result is positive, then it is determined that the ground fault of the bus has disappeared.

In the case of a fault phase, the ratio of zero sequence voltage to positive sequence voltage will not change much, regardless of how the residual voltage on the bus attenuates. Thus, the ratio of zero sequence voltage to positive sequence voltage can be monitored, and if it is found that the change therein is large and the zero sequence voltage has already reached the fifth preset threshold or below, it can be determined that the ground fault of the bus has disappeared. Here, the fourth preset threshold and fifth preset threshold may both be set according to actual needs.

Once the ground fault of the bus has disappeared, a subsequent operation may be performed, for example, unlocking the power supply switching function of the quick-switch apparatus, or triggering the engagement operation of the backup power supply; further details are not given here.

In this embodiment, by monitoring the ratio of zero sequence voltage to positive sequence voltage of the bus where the single-phase ground fault has occurred, it is possible to determine precisely whether the ground fault of the bus has disappeared.

### Embodiment 5

This embodiment provides a quick-switch apparatus located in a power system that also comprises two power supplies, each power supply being connected to a bus by means of an incoming line. One power supply that is currently supplying power is the main power supply and the other power supply acts as the backup power supply; the quick-switch apparatus is used to trigger switching between the two power supplies, and the bus has three phases.

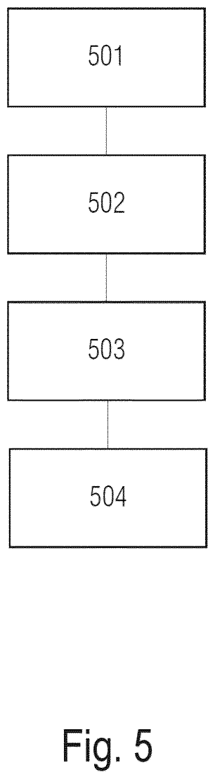

As shown in FIG. 5, the quick-switch apparatus of this embodiment comprises a first monitoring unit 501, a first acquisition unit 502, a judgment unit 503, and a trigger unit 504.

The first monitoring unit 501 is used to monitor a phase voltage of each phase of the bus; the first acquisition unit 503 is used to acquire the rate of decrease of the phase voltage of each phase after the main power supply has been disconnected; the judgment unit 503 is used to judge whether the rate of decrease of the phase voltage of each phase is less than or equal to a first preset threshold, and if the judgment result is positive, trigger a trigger unit 504; and the trigger unit 504 is used to trigger an engagement operation of the backup power supply.

As described in the preceding embodiments, the triggering of the engagement operation of the backup power supply here does not mean that the backup power supply is immediately engaged, but that it is engaged when a preset condition is met. For example, if the fault phase has not disappeared, the backup power supply should not be engaged, so the trigger unit 504 can be disabled; if the fault phase has disappeared, the trigger unit 504 can be unlocked.

The methods of operation of each of the units in this embodiment are the same as in the embodiments described above, so are not described again here.

According to this embodiment, after the main power supply has been disconnected, the rate of decrease of the phase voltage of each phase is monitored to determine whether to trigger the engagement operation of the backup power supply, and it is thus possible to avoid the problems of erroneous engagement or inability to engage promptly.

### Embodiment 6

This embodiment provides a supplementary explanation of the quick-switch apparatus in embodiment 5.

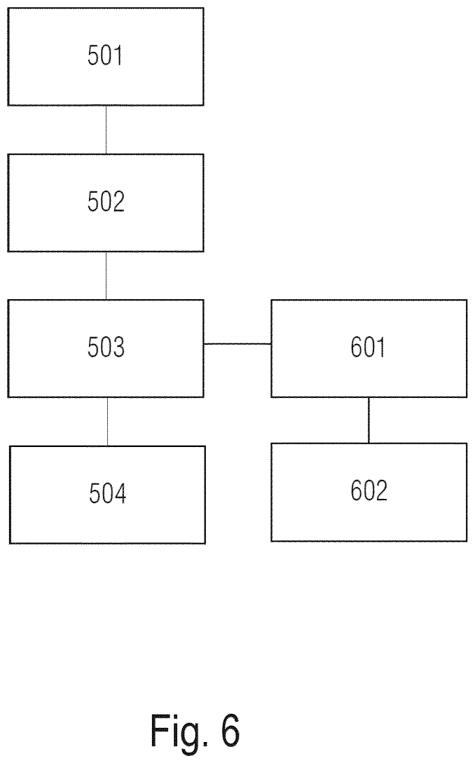

In this embodiment, as shown in FIG. 6, the first acquisition unit 502 is specifically used to:

determine the rate of decrease of the phase voltage of each phase according to the following formula: dU/dt=U(n)−U(n−2T),
where dU/dt represents the rate of decrease of the phase voltage, U(n) represents the value of the nth sampling point of the phase voltage, U(n−2T) represents the value of the (n−2T)th sampling point of the phase voltage, and T represents the period of the phase voltage; or
dU/dt represents the rate of decrease of the phase voltage, U(n) represents the nth amplitude of the phase voltage, U(n−2T) represents the (n−2T)th amplitude of the phase voltage, and T represents the period of the phase voltage.

After the main power supply has been disconnected, the rate of decrease of the phase voltage of each phase is monitored to determine whether to trigger the engagement operation of the backup power supply, and it is thus possible to avoid the problems of erroneous engagement or inability to engage promptly. Moreover, it is also possible to determine whether there is a fault connected to the bus by means of the trend of variation of the phase voltage. This is very simple and convenient.

Optionally, the judgment unit 503 judges whether the rate of decrease of the phase voltage of each phase is greater than the first preset threshold, and then determines that there is a fault connected to the bus, and disables the trigger unit 504. Optionally, the judgment unit 503 is also used to unlock the trigger unit 504 if it is determined that the phase voltage on each phase exhibits a rising trend.

Optionally, the judgment unit 503 is also used to: judge whether a negative sequence voltage occurs on the bus, and if the judgment result is positive, trigger a second acquisition unit 601;
the second acquisition unit 601 is used to acquire the ratio of negative sequence voltage to positive sequence voltage of the bus;
the quick-switch apparatus further comprises a second monitoring unit 602, used to monitor whether the process of variation of the ratio of negative sequence voltage to positive sequence voltage is greater than or equal to a second preset threshold and the negative sequence voltage is less than or equal to a third preset threshold; if the monitoring result is positive, then it is determined that a phase-to-phase fault of the bus has disappeared; or
the judgment unit 503 is also used to: judge whether a negative/zero sequence voltage occurs on the bus, and if the judgment result is positive, trigger a second acquisition unit 601;
the second acquisition unit 601 is used to acquire the ratio of zero sequence voltage to positive sequence voltage of the bus;
the second monitoring unit 602 is used to monitor whether the process of variation of the ratio of zero sequence voltage to positive sequence voltage is greater than or equal to a fourth preset threshold and the zero sequence voltage is less than or equal to a fifth preset threshold; if the monitoring result is positive, then it is determined that a ground fault of the bus has disappeared.

The methods of operation of each of the units in this embodiment are the same as in the embodiments described above, so are not described again here.

In this embodiment, by monitoring the ratio of the negative sequence voltage or zero sequence voltage to the positive sequence voltage on a phase where a single-phase ground fault has occurred, it is possible to precisely determine whether the fault in that phase has disappeared.

The present invention further provides a quick-switch apparatus, comprising at least one memory and at least one processor. The memory is used to store instructions. The processor is used to execute the method for a power system having a quick-switch apparatus as described in any of the embodiments above according to the instructions stored in the memory.

An embodiment of the present invention further provides a readable storage medium. The readable storage medium has stored therein machine-readable instructions, and when the machine-readable instructions are executed by a machine, the machine executes the method for a power system having a quick-switch apparatus as described in any of the embodiments above.

The readable medium stores a machine-readable instruction that, when executed by a processor, causes the processor to execute any one of the above-described methods. Specifically, a system or apparatus equipped with a readable storage medium may be provided; software program code realizing a function of any one of the embodiments above is stored on the readable storage medium, and a computer or processor of the system or apparatus is caused to read and execute a machine-readable instruction stored in the readable storage medium.

In this case, the functions of any one of the above embodiments may be performed by a program code read from the readable medium, so a machine-readable code and a readable storage medium for storing machine-readable code constitute a part of the present invention.

Examples of readable storage media include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, the program code may be downloaded from a server computer or a cloud via a communication network.

Those skilled in the art should understand that various changes in form and amendments may be made to the embodiments disclosed above without departing from the substance of the invention. Thus, the scope of protection of the present invention shall be defined by the attached claims.

It should be noted that not all steps and units in the above-described process flows and system structure diagrams are necessary, and some steps or units may be omitted according to actual needs. The sequence in which the steps are executed is not fixed, but may be adjusted as needed. The apparatus structure described in the above embodiments may be either a physical structure or a logical structure, which means that some units may be implemented by the same physical entity, or some units may be implemented by a plurality of physical entities separately or by some parts of a plurality of independent devices jointly.

In the embodiments above, a hardware unit may be realized in a mechanical or an electrical manner. For example, a hardware unit or processor may comprise a permanently dedicated circuit or logic (for example, a specialized processor, FPGA, or ASIC) to complete corresponding operations. A hardware unit or processor may further comprise programmable logic or circuits (such as general-purpose processors or other programmable processors), which may be temporarily set by software to complete corresponding operations. Particular embodiments (mechanical, or dedicated permanent circuitry, or temporarily set circuitry) may be determined based on considerations of cost and time.

The above are merely preferred embodiments of the present invention, which are not intended to limit it. Any amendments, equivalent substitutions or improvements etc. made within the spirit and principles of the present invention shall be included in the scope of protection thereof.

1-12. (canceled)

13. A method for operating a power system having a quick-switch apparatus and two power supplies, each of the power supplies being connected to a bus via an incoming line, one of the power supplies that is currently supplying power serves as a main power supply, and another of the power supplies serves as a backup power supply, the quick-switch apparatus being used to trigger switching between the two power supplies, and the bus having three phases, which comprises the steps of:
monitoring a phase voltage of each of the phases of the bus;
acquiring a rate of decrease of the phase voltage of each of the phases after the main power supply has been disconnected; and
triggering an engagement operation of the backup power supply if the rate of decrease of the phase voltage of each of the phases is less than or equal to a first preset threshold.

14. The method according to claim 13, wherein the step of acquiring the rate of decrease of the phase voltage of each of the phases further comprises:
determining the rate of decrease of the phase voltage of each of the phases according to a following formula:
$$dU / dt = U ( n ) - U ( n - 2 T ) ,$$
wherein:
dU/dt represents the rate of decrease of the phase voltage, U(n) represents a value of an nth sampling point of the phase voltage, U(n−2T) represents a value of a (n−2T)th sampling point of the phase voltage, and T represents a period of the phase voltage; or
said dU/dt represents the rate of decrease of the phase voltage, said U(n) represents the nth amplitude of the phase voltage, said U(n−2T) represents the (n−2T)th amplitude of the phase voltage, and T represents the period of the phase voltage.

15. The method according to claim 13, wherein, if rates of decrease of the phase voltages are all greater than the first preset threshold, it is determined that there is a fault connected to the bus, and the engagement operation of the backup power supply is prohibited.

16. The method according to claim 15, wherein, after the engagement operation of the backup power supply is prohibited, the method further comprises:
unlocking a prohibition of the engagement operation of the backup power supply if it is judged that the phase voltage on each of the phases exhibits a rising trend.

17. The method according to claim 13, wherein, after monitoring the phase voltage of each of the phases of the bus, the method further comprises:
judging whether a negative sequence voltage occurs on the bus;
acquiring a ratio of the negative sequence voltage to a positive sequence voltage of the bus if a judgment result is positive;
monitoring whether a process of variation of the ratio of the negative sequence voltage to the positive sequence voltage is greater than or equal to a second preset threshold and the negative sequence voltage is less than or equal to a third preset threshold, and if a first monitoring result is positive, determining that a phase-to-phase fault of the bus has disappeared;
or
judging whether a zero sequence voltage occurs on the bus;
acquiring a ratio of the zero sequence voltage to the positive sequence voltage of the bus if a judgment result is positive; and
monitoring whether a process of variation of the ratio of the zero sequence voltage to the positive sequence voltage is greater than or equal to a fourth preset threshold and the zero sequence voltage is less than or equal to a fifth preset threshold, and if a second monitoring result is positive, determining that a ground fault of the bus has disappeared.

18. A quick-switch apparatus, disposed in a power system having two power supplies, each of the power supplies being connected to a bus via an incoming line, one of the power supplies that is currently supplying power serving as a main power supply, and another of the power supplies serving as a backup power supply, the quick-switch apparatus being used to trigger switching between the two power supplies, the bus having three phases, the quick-switch apparatus comprising:
a first monitoring unit for monitoring a phase voltage of each of the phases of the bus;
a first acquisition unit, for acquiring a rate of decrease of the phase voltage of each the phases after the main power supply has been disconnected;
a trigger unit for triggering an engagement operation of the backup power supply; and
a judgment unit, for judging whether the rate of decrease of the phase voltage of each of the phases is less than or equal to a first preset threshold, and if a judgment result is positive, triggering said trigger unit.

19. The quick-switch apparatus according to claim 18, wherein said first acquisition unit is specifically used to:
determine the rate of decrease of the phase voltage of each of the phases according to a following formula:
$$dU / dt = U ( n ) - U ( n - 2 T ) ,$$
wherein:
dU/dt represents the rate of decrease of the phase voltage, U(n) represents a value of an nth sampling point of the phase voltage, U(n−2T) represents a value of a (n−2T)th sampling point of the phase voltage, and T represents a period of the phase voltage; or
said dU/dt represents the rate of decrease of the phase voltage, said U(n) represents the nth amplitude of the phase voltage, said U(n−2T) represents the (n−2T)th amplitude of the phase voltage, and said T represents the period of the phase voltage.

20. The quick-switch apparatus according to claim 18, wherein, if the judgment result of said judgment unit is negative, it is determined that there is a fault connected to the bus, and said trigger unit is disabled.

21. The quick-switch apparatus according to claim 20, wherein said judgment unit is further used to unlock said trigger unit if it is judged that the phase voltage on each of the phases exhibits a rising trend.

22. The quick-switch apparatus according to claim 18,
further comprising a second acquisition unit;
wherein said judgment unit is further used to judge whether a negative sequence voltage occurs on the bus, and if a second judgment result is positive, trigger said second acquisition unit;
wherein said second acquisition unit is used to acquire a ratio of the negative sequence voltage to a positive sequence voltage of the bus;
further comprising a second monitoring unit for monitoring whether a process of variation of the ratio of the negative sequence voltage to the positive sequence voltage is greater than or equal to a second preset threshold and the negative sequence voltage is less than or equal to a third preset threshold, and if a first monitoring result is positive, determining that a phase-to-phase fault of the bus has disappeared;
or
wherein said judgment unit is further used to judge whether a negative/zero sequence voltage occurs on the bus, and if a third judgment result is positive, trigger said second acquisition unit;
said second acquisition unit is used to acquire a ratio of the zero sequence voltage to the positive sequence voltage of the bus;
said second monitoring unit is used for monitoring whether a process of variation of the ratio of the zero sequence voltage to the positive sequence voltage is greater than or equal to a fourth preset threshold and the zero sequence voltage is less than or equal to a fifth preset threshold, and if a second monitoring result is positive, determining that a ground fault of the bus has disappeared.

23. A quick-switch apparatus, comprising:
at least one memory for storing instructions; and
at least one processor for executing the method for operating the power system having the quick-switch apparatus according to claim 13 according to the instructions stored in said at least one memory.

24. A readable non-transitory storage medium storing machine-readable instructions, and when the machine-readable instructions are executed by a machine, the machine executes the method for operating the power system having the quick-switch apparatus according to claim 13.
